(19) United States
(12) Patent Application Publication
(10) Pub. No.: US 2009/0171747 A1
(43) Pub. Date: Jul. 2, 2009

(54) PRODUCT ACTIVATION/REGISTRATION AND OFFER ELIGIBILITY

(75) Inventors: Van Stephen Lanning, Bellevue, WA (US); Michelle C. Mackey, Kirkland, WA (US); Taj Lamon Thoresen, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/964,056

(22) Filed: Dec. 26, 2007

(51) Int. Cl. G06Q 30/00; G06F 21/00

(52) U.S. Cl. 705/10; 705/26; 726/28

(57) ABSTRACT

An offer may be provided to a user in conjunction with activating or registering a software product. A request for activation of the software product or registration of the software product may be sent to a server via a network. In response to receiving the request, the server may send an activation code to the processing device, or may record the registration of the software product, respectively. The server may work with components of the system to determine whether the user is eligible to receive one or more offers based on the software product and user information. The user may accept one of the one or more offers and the system may provide a corresponding order, along with at least some of the user information, to a processing device of a vendor.

### BACKGROUND

A user may install a software product on a processing device, may request activation of the software product by electronically sending product information to a remote server, and may electronically receive a product activation code, which may fully enable all features of the installed software product on the processing device. Further, a user may electronically register ownership of a software product.

A user may receive offers from various vendors, such as, for example, software product vendors, after having purchased a software product from one of the software product vendors. However, no existing system presents a user with one or more offers, for which the user is eligible, in conjunction with electronically registering or activating the software product.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a system may be provided which may provide an offer to a user in conjunction with activating a software product. A user may install a software product on a processing device. The user may cause a request to activate the software product to be sent to a remote processing device, such as, for example, a server, via a network. In response to receiving the request, an activation code may be sent to the processing device to enable all features of the software product. In addition, the server may work with one or more components of the system to determine whether the user is eligible to receive one or more offers based, at least in part, on the software product and stored user information. The user may accept one of the one or more offers and the system may provide an order, based on the accepted one of the one or more offers, along with at least some of the user information, to a processing device of a vendor.

In other embodiments consistent with the subject matter of this disclosure, a method and a system may be provided which may provide an offer to a user in conjunction with registering a software product. A user may register a software product via a processing device. The processing device may communicate software product registration information to a remote processing device, such as, for example, a server, via a network. In response to receiving the software product registration information, the server may store information with respect to the software product registration in a database. Further, the server may work with one or more components of the system to determine whether the user is eligible to receive one or more offers based, at least in part on a software product and stored user information. The user may accept one of the one or more offers and the system may provide an order, based on the accepted one of the one or more offers, along with at least some of the user information, to a processing device of a vendor.

In the above-described embodiments, the system may periodically determine one or more additional offers for which the user is eligible and may electronically send offer information to the user. The offer information may be sent via email, Rich Site Summary feed, or other electronic means.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment for embodiments consistent with the subject matter of this disclosure.

FIG. 2 is a functional block diagram of an exemplary processing device, which may implement processing devices shown in FIG. 1.

FIG. 3 is a functional block diagram illustrating various components which may be included in an embodiment of a system consistent with the subject matter of this disclosure.

FIGS. 4, 5, and 7-11 or flowcharts illustrating exemplary processing in embodiments consistent with the subject matter of this disclosure.

FIG. 6 is an exemplary display, which may be presented to a user, for providing product information and user identifying information in an embodiment consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a system and a method in which a user may electronically register or activate a software product and electronically receive at least one offer for which the user is eligible in response to and based, at least partly, on the electronic registering or the activating of the software product.

In a first embodiment consistent with the subject matter of this disclosure, a user may install a software product on a processing device and may request activation of the software product. All features of the software product may not be enabled until the software product is activated. The request for activation may be sent to a first server via a network and may include product information and information describing the processing device. The first server may determine whether activation of the software product is authorized based on the product information and the information describing the processing device. If the activation of the software product is determined to be authorized, the first server may send an authorization code to the processing device, which may then enable all features of the software product installed on the processing device.

In some embodiments, the request for activation may be sent with user identifying information, such as, for example, a user ID and password, or other user identifying information. The user identifying information may then be authenticated to determine whether the user is a valid user, and user information, with respect to the user, may be accessed. The user information may include information with respect to software products activated by the user, age of the user, preferences and interests of the user, gender of the user, credit information of the user, billing address of the user, shipping address of the user, and/or other information with respect to the user.

An offer eligibility engine, which may be included in the first server or a second server, may determine one or more offers for which the user is eligible based on the product information and/or the user information. Information describing an activation status of one or more software products associated with the user and one or more offers for which the user is eligible may be presented to the user via a display monitor of the processing device. The user may accept one of the one or more offers. Information describing the offer and at least some of the user information may be electronically provided to a vendor associated with the one of the one or more offers.

In a second embodiment consistent with the subject matter of this disclosure, a user may electronically register a software product from a processing device via a network. Product information, describing the software product, as well as user identifying information, may be provided to a first server. The first server may authenticate the user identifying information and may permit access to user information with respect to the user. The user information may include information with respect to software products registered by the user, age of the user, preferences and interests of the user, gender of the user, credit information of the user, billing address of the user, shipping address of the user, and/or other information with respect to the user. Registration of the software product may be recorded in a database.

In the second embodiment, an offer eligibility engine may be included in the first server or a second server. The offer eligibility engine may determine one or more offers for which the user is eligible based on the product information and/or the user information. Information describing products registered to the user and one or more offers for which the user is eligible may be presented to the user via a display monitor of the processing device. The user may accept one of the one or more offers. Information describing the offer and at least some of the user information may be electronically provided to a vendor associated with the one of the one or more offers.

In various embodiments consistent with the subject matter of this disclosure, a determination may be made periodically regarding other offers for which the user may be eligible. Information describing the other offers may be electronically sent to the user.

### Exemplary Operating Environment

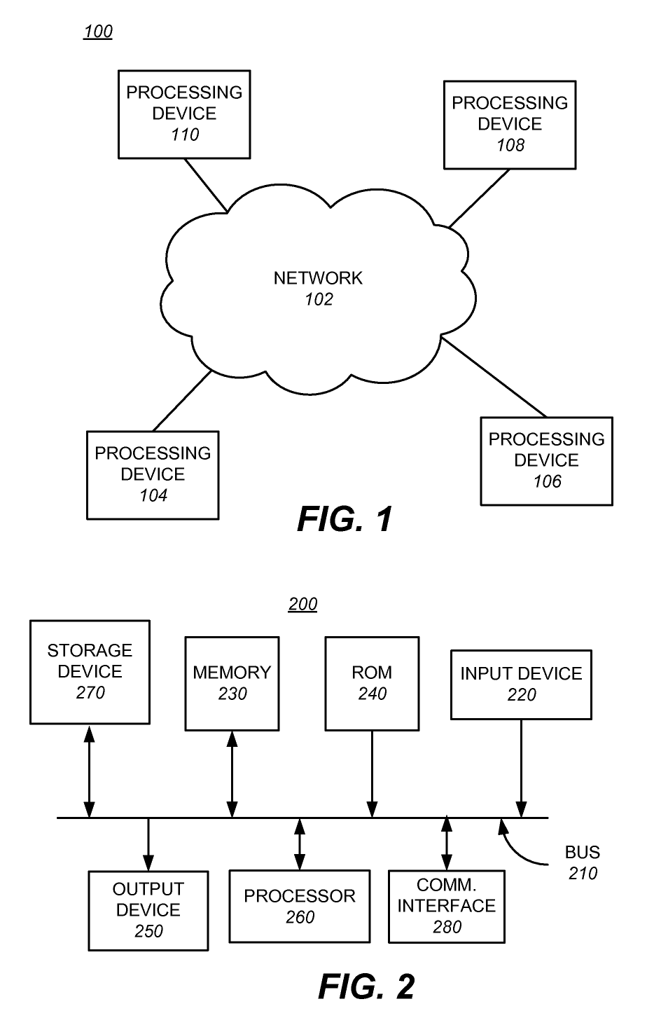

FIG. 1 illustrates an exemplary operating environment 100 consistent with the subject matter of this disclosure. Exemplary operating environment 100 may include a network 102 and processing devices 104, 106, 108, 110 connected to network 102.

Network 102 may be a single network or a combination of networks, such as, for example, the Internet or other networks. Network 102 may include a wireless network, a wired network, a packet-switching network, a public switched telecommunications network, a fiber-optic network, other types of networks, or any combination of the above.

Processing device 104 may be a user's processing device, such as, for example, a desktop personal computer (PC), a laptop PC, a handheld processing device, or other processing device.

Processing devices 106, 108, 110 may be servers. In some embodiments, one or more of the servers may include multiple servers configured to work together as a server farm.

### Exemplary Processing Device

FIG. 2 is a functional block diagram of an exemplary processing device 200, which may be used in embodiments consistent with the subject matter of this disclosure to implement any or all of processing devices 104, 106, 108, 110. Processing device 200 may include a bus 210, an input device 220, a memory 230, a read only memory (ROM) 240, an output device 250, a processor 260, a storage device 270, and a communication interface 280. Bus 210 may permit communication among components of processing device 200.

Processor 260 may include at least one conventional processor or microprocessor that interprets and executes instructions. Memory 230 may be a random access memory (RAM) or another type of dynamic storage device that stores information and instructions for execution by processor 260. Memory 230 may also store temporary variables or other intermediate information used during execution of instructions by processor 260. ROM 240 may include a conventional ROM device or another type of static storage device that stores static information and instructions for processor 260. Storage device 270 may include a compact disc (CD), digital video disc (DVD), a magnetic medium, or other type of storage device for storing data and/or instructions for processor 260.

Input device 220 may include a keyboard, a joystick, a pointing device or other input device. Output device 250 may include one or more conventional mechanisms that output information, including one or more display monitors, or other output devices. Communication interface 280 may include a transceiver for communicating via one or more networks via a wired, wireless, fiber optic, or other connection.

Processing device 200 may perform such functions in response to processor 260 executing sequences of instructions contained in a tangible machine-readable medium, such as, for example, memory 230, ROM 240, storage device 270 or other medium. Such instructions may be read into memory 230 from another machine-readable medium or from a separate device via communication interface 280.

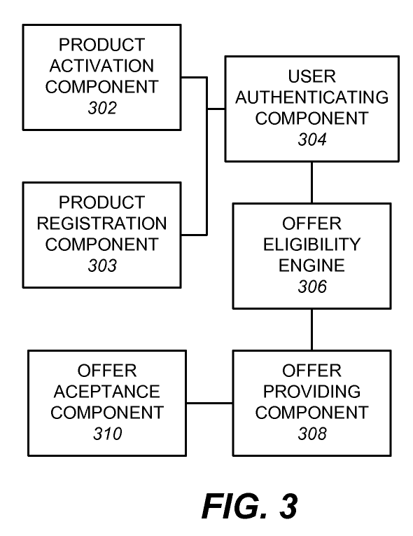

FIG. 3 is a functional block diagram of an embodiment of a system consistent with the subject matter of this disclosure. The system may include a product activation component 302 and/or a product registration component 303, as well as a user authenticating component 304, an offer eligibility engine 306, an offer providing component 308, and an offer acceptance component 310. The system may be implemented completely on one of processing devices 106, 108, 110, or on a combination of two or more of processing devices 106, 108, 110 and network 102. Processing device 104 may be a user's processing device.

Product activation component 302 may receive a request from a user's processing device, such as, for example, processing device 104, to activate a software product and may send an activation code to the user's processing device to enable all features of the software product installed on the user's processing device.

Product activation component 302 may receive a request to register a software product from the user's processing device and may register the software product.

User authenticating component 304 may receive user identifying information, such as, for example, a user ID and a password, or other user identifying information, from the user's processing device and may authenticate a user based on the received user identifying information. User authenticating component 304 may provide access to user information when the user is authenticated. It should be noted, that some embodiments may not include user authenticating component 304.

Offer eligibility engine 306 may determine whether a user is eligible to receive one or more offers based on one or more activated or registered software products, associated with the user, and based on the user information.

Offer providing component 308 may provide information with respect to the one or more offers for which the user is eligible. Offer providing component 308 may provide the information to the user's processing device to be displayed on a display monitor of the user's processing device.

Offer acceptance component 310 may received information with respect to one or more offers accepted by the user via the user's processing device.

### Exemplary Processing

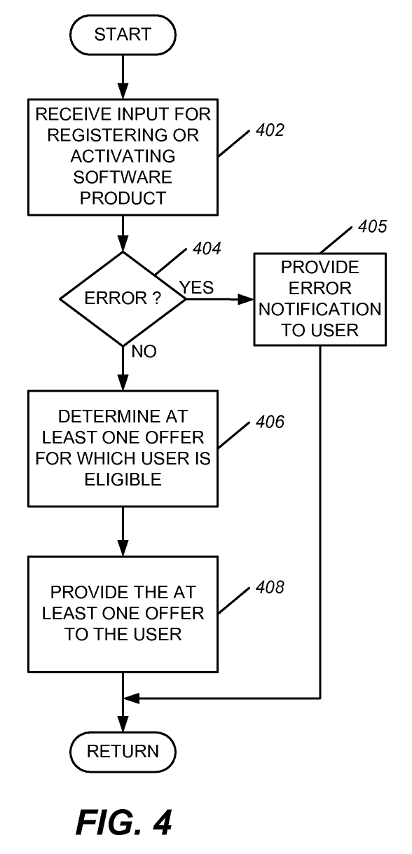

FIG. 4 is a flowchart illustrating exemplary processing, which may be performed in embodiments consistent with the subject matter of this disclosure. The process may begin with either product activation component 302 or product registration component 303 receiving a request for software product activation or a request for software product registration, respectively, from a user's processing device, such as, for example, processing device 104 (act 402).

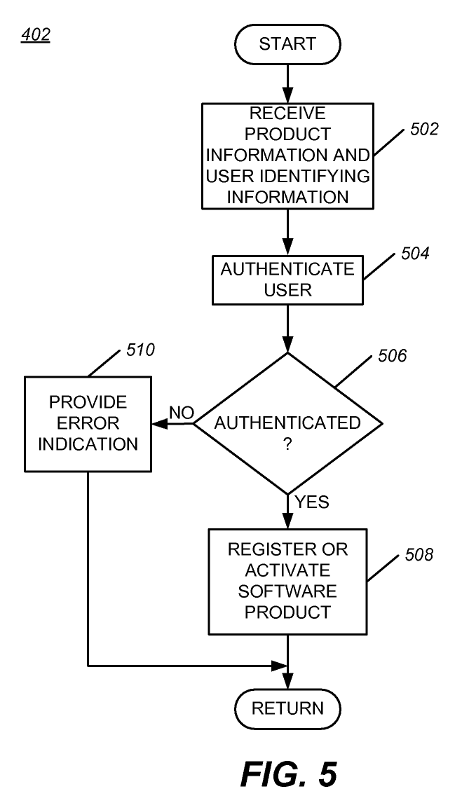

FIG. 5 is a flowchart illustrating exemplary processing with respect to act 402 of FIG. 4. The process may begin with either product activation component 302 or product registration component 303 receiving product information and, in some embodiments, user identifying information (act 502). The product information may include information describing a software product. The information describing the software product may include a code having information with respect to a product type, which may indicate an operating system under which the software product may execute, a product subtype, which may indicate whether the software product is a retail version or an original equipment manufacturer (OEM) version, a product language, and/or other information. In an embodiment in which the user identifying information is received, the user identifying information may include a user ID and password, and/or other information which may be used to identify a user.

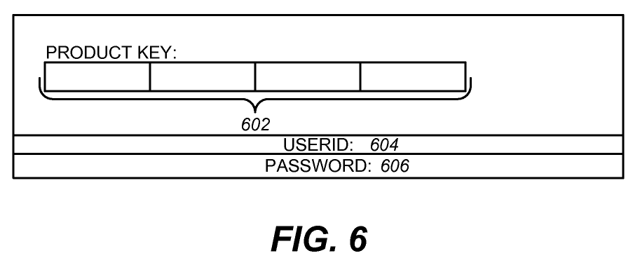

FIG. 6 illustrates an exemplary display, which may be presented to a user via a display monitor of a processing device. The user may enter product information in a form of a product key. The product key may be provided via product key input area 602. The product key may include the above-mentioned code having information with respect to the product type and the product subtype. The user may enter user identifying information, such as, for example, a user ID and a password, via userid input area 608 and password input area 610, respectively.

Returning to FIG. 5, in an embodiment which receives the user identifying information, product activation component 302 or product registration component 303 may provide the user identifying information to user authenticating component 304, which may authenticate the user based on the identifying information (act 504). A determination may then be made regarding whether the user is successfully authenticated based on the provided user identifying information (act 506). If the user is not successfully authenticated, then an error indication may be provided (act 510). Otherwise, either product registration component 303 may register the software product or product activation component 302 may determine whether the software product is authorized to be activated and may send an activation code to the user's processing device to activate the software product installed thereon (act 508). The process may then be completed.

In an embodiment in which the user identifying information is not received, acts 504, 506 and 510 may not be performed.

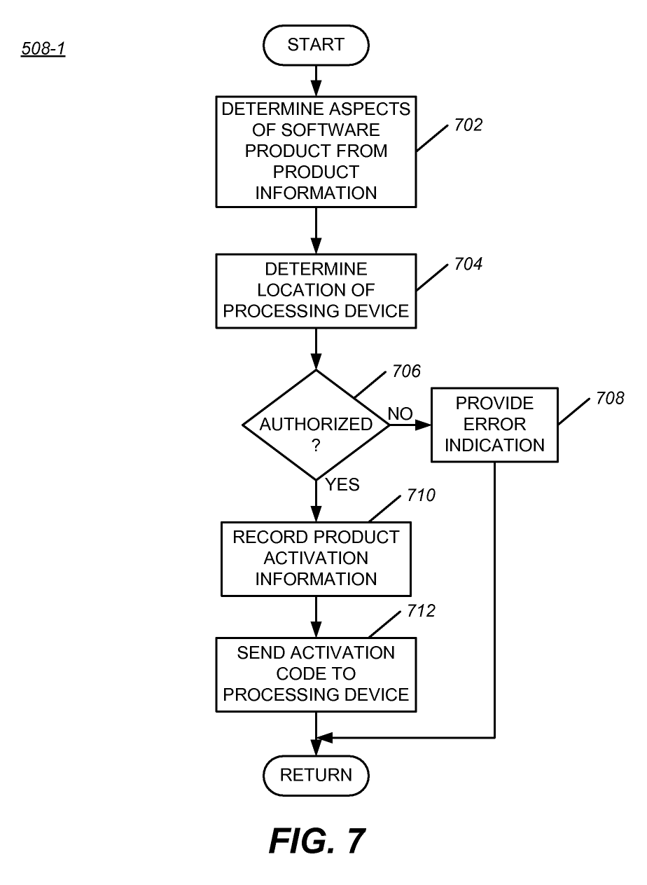

FIG. 7 is a flowchart illustrating an exemplary process 508-1 for performing act 508 of FIG. 5, with respect to activating the software product. The process may begin with product activation component 302 determining aspects of the software product, such as, for example, a product type, product subtype, and/or other information about the software product, from the received product information, which may include a product key (act 702). A location of the user's processing device may then be determined (act 704). In some embodiments, the location may be determined by a calling address, such as, for example, and Internet Protocol (IP) address, or other address, which may be included in a communication including a request for product activation received from the user's processing device.

Next, product activation component 302 may determine whether the software product is authorized to be activated based on any of a number of different factors, such as, for example, receipt of a valid product key, hardware information (which may be included in a request for software product activation) describing hardware aspects of the user's processing device, the location of the user's processing device, product type, product subtype, and/or other factors (act 706).

If product activation component 302 determines that the software product is not authorized to be activated, then an error indication may be provided (act 708) and the process may be completed. Otherwise, product activation component 302 may record information with respect to product activation of the software product in a database (act 710). Product activation component 302 may further store aspects of the information with respect to the product activation in a database including user information. Product activation component 302 may then send an activation code to the user's processing device to cause all features of the corresponding installed software product to be enabled (act 712).

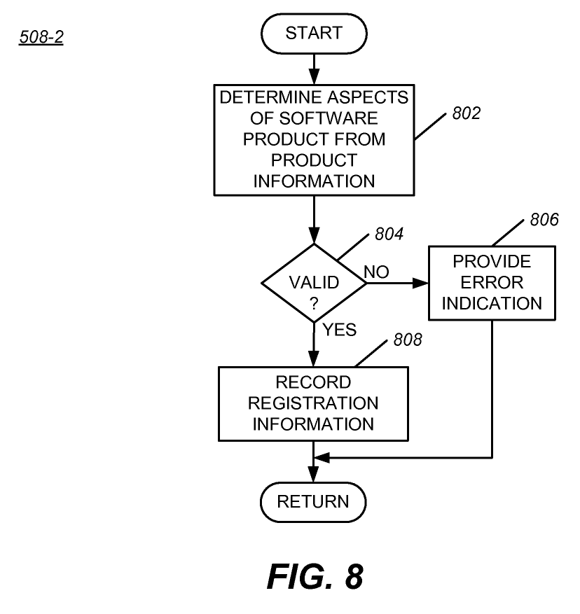

FIG. 8 is a flowchart illustrating an exemplary process 508-2 for performing act 508 of FIG. 5, with respect to registering a software product. The process may begin with product registration component 303 determining aspects of the software product from received product information (act 802). In some embodiments, the received product information may include a product key, which may provide information such as, for example, product type, product subtype and/or other product information.

Product registration component 303 may then determine whether the received product information describes a valid software product (act 804). If the received product information does not describe a valid software product, then an error indication may be provided (act 806). Otherwise, information regarding the software product may be recorded in a database (act 808). The information may further be recorded in a database including user information.

Returning to FIG. 5, the process may end and a determination may be made regarding whether an error indication was provided (act 404; FIG. 4). If an error indication was provided, then an error notification may be sent to the user's processing device and may be provided to the user via a display monitor of the user's processing device (act 405). The process may then be completed. Otherwise, offer eligibility engine 306 may be requested to determine if there is at least one offer for which the user is eligible (act 406).

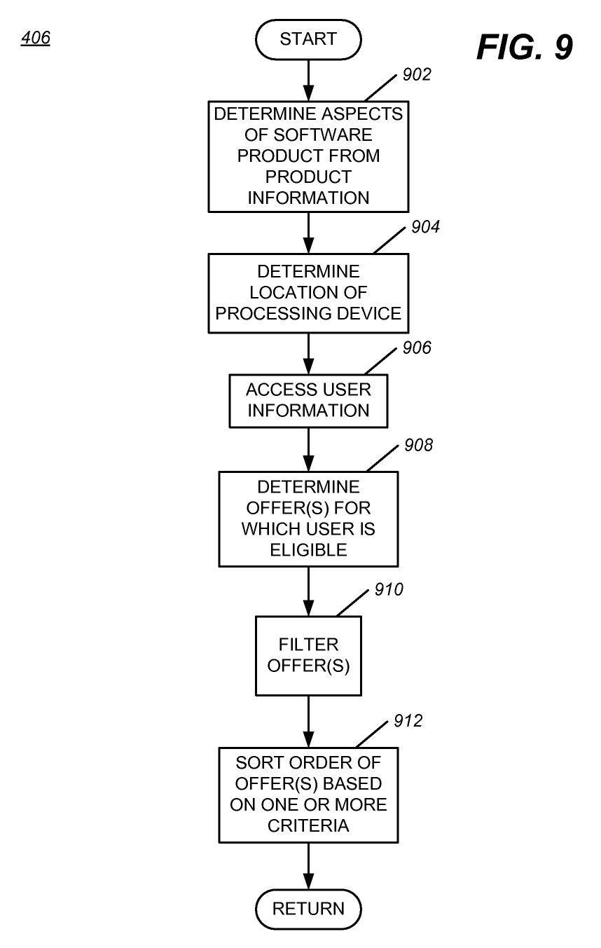

FIG. 9 is a flowchart illustrating an exemplary process, which may be performed by offer eligibility engine 306 to determine any offers for which the user is eligible. The process may begin with offer eligibility engine 306 determining aspects of a software product from received product information (act 902). For example, the received product information may include a product key having information with respect to a product type, a product subtype, a language of the product and/or other information with respect to the software product.

Offer eligibility engine 306 may then determine a location of the user's processing device (act 904). As mentioned previously, the location may be determined by a calling address, such as, for example, an Internet Protocol (IP) address, or other address, which may be included in a communication including a request for product activation or a request for software product registration received from the user's processing device.

Offer eligibility engine 306 may then access user information, with respect to the user (act 906). Offer eligibility engine 306 may access the user information by using the user identifying information, which may be included in a communication including the request for product activation or the request for software product registration. The user information may include, for example, a user's name, a user's age, a user's billing address, a user's shipping address, a user's credit information, a user's gender, a user's preferences and interests, and/or other information.

Offer eligibility engine 306 may then determine offers for which the user is eligible based on the user information and product information describing one or more software products the user activated or registered (act 908).

Offer eligibility engine 306 may filter offers based on various criteria, such as, for example, a user's age, a language associated with the software product (English, French, etc.), and/or other criteria (act 910). For example, if the user is under 18 years of age, offers requiring the user to be at least 18 years of age will be filtered out. Further, if the user is old enough to be considered a senior citizen, then offers, which may include senior citizen discounts, may not be filtered out.

Offer eligibility engine 306 may then sort the filtered offers based on one or more criteria (act 912). For example, the filtered offers may be sorted based on activation status of a software product, a user's preferences/interests, offer type (free or not free), a user's gender, a user's age, and/or other criteria. The process may then be completed.

Returning to FIG. 4, at least one of the offers for which the user is eligible may then be provided to the user by offer providing component of 308 (act 408). In some embodiments, information with respect to at least one of the offers may include an activation status of the software product and the sorted list of offers, which may be provided to the user's processing device for display on a display monitor.

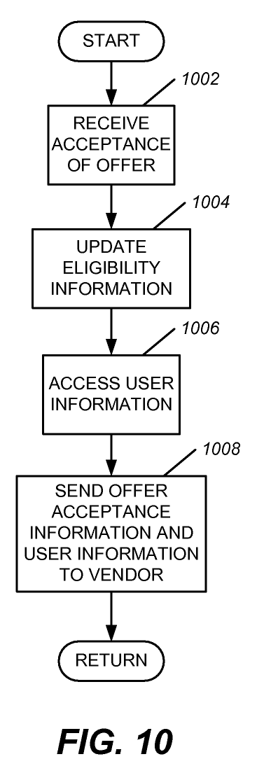

FIG. 10 is a flowchart illustrating an exemplary process for processing a user's acceptance of an offer. The process may begin with offer acceptance component 310 receiving an acceptance of an offer (act 1002). Offer acceptance component 310 may then update eligibility information with respect to the user (act 1004). For example, if the user is eligible for one of offers A, B, or C because the user requested activation of software product X, then the eligibility information, with respect to the user, may be updated to reflect that the user accepted one of the offers A, B, C (for example, offer A) and is no longer eligible for other offers (for example, offers B and C). In some embodiments, the eligibility information may be stored as part of the user information.

Next, user information, with respect to the user may be accessed based on the provided user identifying information (act 1006). Offer acceptance component 310 may then provide offer acceptance information and at least some of the user information to a vendor (act 1008). The offer acceptance information may include information regarding the offer such as, for example, a product key, a coupon code, a price, and/or other information. The user information may include a user's name, a user's age, a user's billing address, a user's shipping address, a user's credit information and/or other information. The process may then be completed.

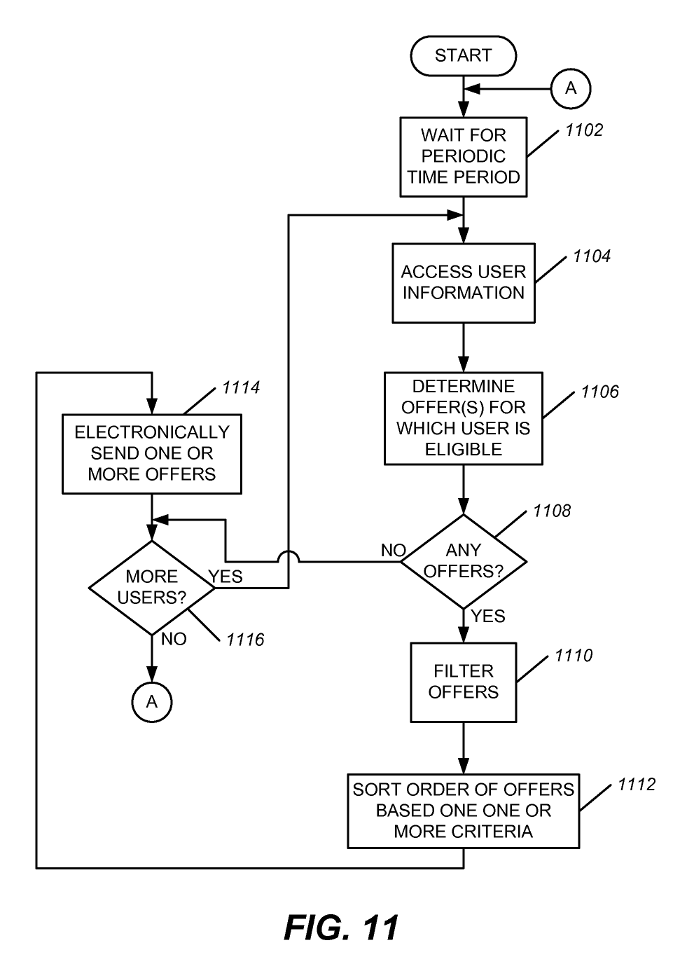

FIG. 11 is a flowchart illustrating an exemplary process for periodically providing or pushing offers to eligible users. The process may begin by waiting for a periodic time period (act 1102). The periodic time period may be weekly, annually, monthly, or another periodic time period.

Next, user information for a user may be accessed (act 1104). Offer eligibility engine 306 may then determine offers for which the user is eligible (1106). The determination may be made based on the user information and one or more software products associated with the user (for example, one or more software products activated or registered by the user). Offer eligibility engine 306 may then determine whether there are any offers for which the user is eligible. If the user is eligible for any offers, then offer eligibility engine 306 may filter offers (act 1110), as previously described with respect to act 910 of FIG. 9. Offer eligibility engine may then a sort an order of offers based on one or more criteria (act 1112), as previously described with respect to act 912 of FIG. 9. The filtered and sorted offers may then be electronically sent to the user (act 1114). In some embodiments, the filtered and sorted offers may be sent via email, Rich Site Summary (RSS) feed, or other method of electronic transmission.

A determination may be made regarding the whether there is additional user information for users (act 1116). If there is additional user information for users, then acts 1104-1116 may be repeated for a next user. Otherwise, act 1102 may again be performed to wait for the periodic time period.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. For example, in some embodiments, when a user requests activation of a software product, or registration of a software product, the user may request that no offers be provided. In other embodiments, the user may request that offers be filtered or not be filtered. Further, implementations consistent with the subject matter of this disclosure may have more or fewer acts than as described, or may implement acts in a different order than as shown. Accordingly, the appended claims and their legal equivalents define the invention, rather than any specific examples given.

We claim as our invention:

1. A machine-implemented method for making offers to a user, the machine-implemented method comprising:
performing one of electronically registering or activating a software product;
determining at least one offer for which the user is eligible in conjunction with and based, at least in part, on the one of electronically registering or activating the software product; and
electronically providing the at least one offer to the user.

2. The machine-implemented method of claim 1, further comprising:
periodically determining one or more additional offers for which the user is eligible; and
electronically delivering the one or more additional offers by pushing the one or more additional offers to the user.

3. The machine-implemented method of claim 1, wherein the performing of one of electronically registering or activating a software product further comprises:
authenticating the user.

4. The machine-implemented method of claim 1, wherein:
the performing of one of electronically registering or activating a software product further comprises the activating of the software product; and
the machine-implemented method further comprises:
authenticating the user; and
filtering ones of the at least one offer based on stored user information about the user.

5. The machine-implemented method of claim 1, wherein:
the performing of one of electronically registering or activating a software product further comprises the activating of the software product, the activating of the product further comprising:
receiving product information and processing device information with respect to a processing device on which the software product is installed;
determining whether the software product is authorized for activation on the processing device based on the product information and the processing device information; and
sending an activation code to the processing device to enable all features of the software product.

6. The machine-implemented method of claim 1, wherein the determining of at least one offer for which the user is eligible in conjunction with and based, at least in part, on the one of electronically registering or activating the software product further comprises:
determining a location of a processing device having the software product installed;
accessing user information with respect to the user; and
determining the at least one offer for which the user is eligible based, at least in part, on provided product information regarding the software product, the determined location of the processing device and the user information.

7. The machine-implemented method of claim 1, further comprising:
periodically determining one or more additional offers for which the user is eligible; and
delivering the one or more additional offers via email or a Rich Site Summary feed.

8. The machine-implemented method of claim 1, further comprising:
electronically receiving an acceptance of one of the at least one offer;
accessing user information with respect to the user in response to electronically receiving the acceptance of the one of the at least one offer; and
electronically providing an order, with respect to the acceptance of the one of the at least one offer, and the user information to a vendor's processing device.

9. A system for activating a software product and providing at least one offer, the system comprising:
a product activation component to receive product information, describing the software product, and processing device information, describing a processing device on which the software product is installed, to determine whether the software product is authorized for activation on the processing device, and to send an activation code to the processing device to enable all features of the software product when the software product is determined to be authorized for activation;
an offer eligibility engine to determine the at least one offer for which a user of the processing device is eligible based, at least in part, on the software product to be activated; and
an offer providing component to provide the at least one offer to the processing device for display.

10. The system of claim 9, wherein:
the offer eligibility engine further determines a location of the processing device, a product type, and a product sub-type and determines the at least one offer based, at least in part, on the product type, the product sub-type, and the location of the processing device.

11. The system of claim 9, further comprising:
a user authenticating component to authenticate the user and provide access to user information, wherein
the offer eligibility engine further determines the at least one offer based, at least in part, on the user information.

12. The system of claim 9, wherein the offer providing component is further for electronically providing the at least one offer via email or a Rich Site Summary feed.

13. The system of claim 9, further comprising:
an offer acceptance component for accepting one of the at least one offer and providing information with respect to one of the at least one offer and user information to a vendor.

14. A machine-implemented method for activating a software product and determining eligibility for at least one offer, the machine-implemented method comprising:
receiving software product information from a processing device having the software product installed thereon;
receiving user identifying information from the processing device;
authenticating the user based on the user identifying information;
determining whether the software product is authorized to be activated based on the received software product information;
sending an activation code to the processing device when the software product is determined to be authorized to be activated;
accessing user information based on the user identifying information when the user is authenticated;
determining whether the user is eligible for at least one offer based, at least in part, on the software product information and the user information; and
providing information with respect to the at least one offer.

15. The machine-implemented method of claim 14, further comprising:
filtering a plurality of offers to provide the at least one offer for which the user is eligible based, at least in part, on the user information.

16. The machine-implemented method of claim 14, further comprising:
filtering a plurality of offers to provide the at least one offer for which the user is eligible based, at least in part, on the user information; and
sorting an order of the filtered at least one offer based on at least one criterion.

17. The machine-implemented method of claim 14, further comprising:
determining, periodically, whether the user is eligible for at least one additional offer based, at least in part, on at least one software product associated with the user and the user information; and
pushing, periodically, information, with respect to the at least one additional offer, to the user.

18. The machine-implemented method of claim 14, further comprising:
determining, periodically, whether the user is eligible for at least one additional offer based, at least in part, on at least one software product associated with the user and the user information; and
providing, periodically, the user with information with respect to the at least one additional offer via email or Rich Site Summary feed.

19. The machine-implemented method of claim 14, wherein:
the user information includes billing information; and
the machine-implemented method further comprises:
receiving an acceptance of one of the at least one offer; and
providing the billing information and an order based on offer information to a processing device of a vendor.

20. The machine-implemented method of claim 14, wherein the providing of the information with respect to the at least one offer further comprises:
providing an activation status of the software product and a list of the at least one offer.
